(19) United States
(12) Patent Application Publication
(10) Pub. No.: US 2020/0407037 A1
(43) Pub. Date: Dec. 31, 2020

(54) AEROSPACE DUST COVER

(71) Applicant: GENTEX CORPORATION, Zeeland, MI (US)

(72) Inventors: Kevin L. Ash, Grand Rapids, MI (US); Gary J. Dozeman, Zeeland, MI (US); Bradley L. Busscher, Grand Rapids, MI (US); Peter T. Kantola, Ravenna, MI (US); Stephen M. Vruggink, Zeeland, MI (US)

(73) Assignee: GENTEX CORPORATION, Zeeland, MI (US)

(21) Appl. No.: 16/914,625

(22) Filed: Jun. 29, 2020

Related U.S. Application Data
(60) Provisional application No. 62/868,353, filed on Jun. 28, 2019.
(60) Provisional application No. 62/971,250, filed on Feb. 7, 2020.

(51) Int. Cl. B64C 1/14; C03C 27/10

(52) U.S. Cl. CPC B64C 1/1492; C03C 2201/32; C03C 27/10

(57) ABSTRACT

A dust cover for an aerospace window that comprises dust cover having an exterior substrate and an interior substrate in a spaced apart relationship with a substantially transparent coupling agent therebetween. The dust cover is disposed in a spaced apart relationship from an electro-optic element, defining a gap therebetween. The gap 30 mm or less, 25 mm, 20 mm, 15 mm, 10 mm, 8 mm, 7 mm, 6 mm, 5 mm, 4 mm, 3.5 mm, and/or 3 mm. The exterior substrate, the coupling agent, and the interior substrate are comprised of a combination of materials, such that the combination is substantially transparent and operable to resist breaking and maintain sufficient rigidity to prevent the electro-optic from breaking, when a force of 680 N is applied to an interior surface of the interior substrate in the direction of the electro-optic element.

### CROSS-REFERENCE TO RELATED APPLICATIONS

This application claims priority under U.S.C. § 119(e) to U.S. Provisional Application No. 62/868,353 filed on Jun. 28, 2019, entitled “IMPROVED AEROSPACE DUST COVER,” and U.S. Provisional Application No. 62/971,250 filed on Feb. 7, 2020, entitled “IMPROVED AEROSPACE DUST COVER,” the disclosures of which are hereby incorporated by reference in their entireties.

### FIELD OF INVENTION

The present disclosure generally relates to an aircraft window assembly, and more specifically, to an aircraft window assembly that includes a protective dust cover.

### BACKGROUND OF INVENTION

Electro-optic elements and aerospace dust covers have been well known for several years. The use of electro-optic elements in airplane windows has the advantage of allowing the window to be variably dimmed. However, electro-optic elements are expensive. Accordingly, it is desirable to protect the electro-optic element with a dust cover.

Presently, however, aerospace dust covers are prone to excessive scratching and are too weak and flexible to provide sufficient protection for the electro-optic element. Further, due to weight concerns, the dust covers cannot simply be replaced with stronger materials. In order to provide protection to the electro-optic element, these weak and flexible dust covers are spaced at relatively greater distances from the electro-optic element. This distance required between the dust cover and the electro-optic element is problematic for aircraft, where space and weight are a premium. Accordingly, there is a need for an improved aerospace dust cover that provides protection to the electro-optic element sufficient to enable a smaller spacing between the electro-optic element and the dust cover, while minimizing its weight.

### SUMMARY

In accordance with the present disclosure, the disadvantages and problems associated with protecting an electro-optic element at smaller spacing between the electro-optic element and the dust cover have been substantially reduced or eliminated.

In accordance with one embodiment of the present disclosure, a window assembly is disclosed. The window assembly comprises a dust cover and an electro-optic element. The dust cover comprises a first substrate and a second substrate in a spaced apart relationship, coupled together by a substantially transparent coupling agent therebetween. The dust cover operable, when a force of 680 N is applied to the dust cover, to: resist breaking and maintain sufficient rigidity to prevent the electro-optic from breaking. The electro-optic element comprising a third substrate, a fourth substrate, a primary seal, and an electrochromic medium. The fourth substrate in a spaced apart relationship with the third substrate. The primary seal defining a chamber with the third and fourth substrates. The electro-optic medium disposed in the chamber.

In accordance with another embodiment of the present disclosure, a window assembly is disclosed. The window assembly comprises a pressure pane, a bezel, an electro-optic element, and a dust cover. The bezel proximate a periphery of the pressure pane and defining an inner opening, the bezel including an inner wall with a channel. The electro-optic element disposed in the inner opening and configured for reception in the channel of the inner wall and having a changeable degree of light transmission. The dust cover proximate the bezel and comprising a first substrate and a second substrate in a spaced apart relationship, coupled together by a substantially transparent coupling agent therebetween. Further, when a force of 680 N is applied to the dust cover, the dust cover operable to resist breaking and maintain sufficient rigidity to prevent the electro-optic from breaking.

In accordance with another embodiment of the present disclosure, a window assembly is disclosed. The window assembly comprises an electro-optic element and a dust cover. The electro-optic element is configured for reception in a channel of an inner wall, the electro-optic element having a changeable degree of light transmission. The dust cover is configured for reception proximate a bezel and comprises a first substrate and a second substrate in a spaced apart relationship, coupled together by a substantially transparent coupling agent therebetween. Further, the dust cover operable, when a force of 680 N is applied to the dust cover to resist breaking and maintain sufficient rigidity to prevent the electro-optic from breaking.

The technical advantages of certain embodiments of the present disclosure include enabling the window to sustain impacts without breaking the expensive electro-optic element and having the dust cover disposed with a smaller gap between the electro-optic element and the dust cover. Additionally, the present disclosure has the advantage of achieving this outcome while keeping weight low, minimizing spalling, and remaining transparent. Thus, certain embodiment have the technical advantage of providing a stronger protective barrier, than prior solutions, between electro-optic element and dust cover, with a reduced gap therebetween.

These and other aspects, objects, and features of the present disclosure will be understood and appreciated by those skilled in the art upon studying the following specification, claims, and appended drawings. It will also be understood that features of each embodiment disclosed herein may be used in conjunction with, or as a replacement for, features in other embodiments.

### BRIEF DESCRIPTION OF FIGURES

In the drawings:

FIG. 1: An exploded view of an aerospace window assembly.

FIG. 2: A cross sectional schematic of an improved aerospace window.

FIG. 3: An exploded perspective view of an embodiment of a dust cover.

### DETAILED DESCRIPTION

The specific devices illustrated in the attached drawings and described in this disclosure are simply exemplary embodiments of the inventive concepts defined in the appended claims. Hence, specific dimensions and other physical characteristics relating the embodiments disclosed herein are not to be considered as limiting, unless the claims expressly state otherwise.

The present disclosure is directed to an aerospace dust cover with sufficient strength and rigidity to prevent an electro-optic element from breaking while enabling a small gap therebetween.

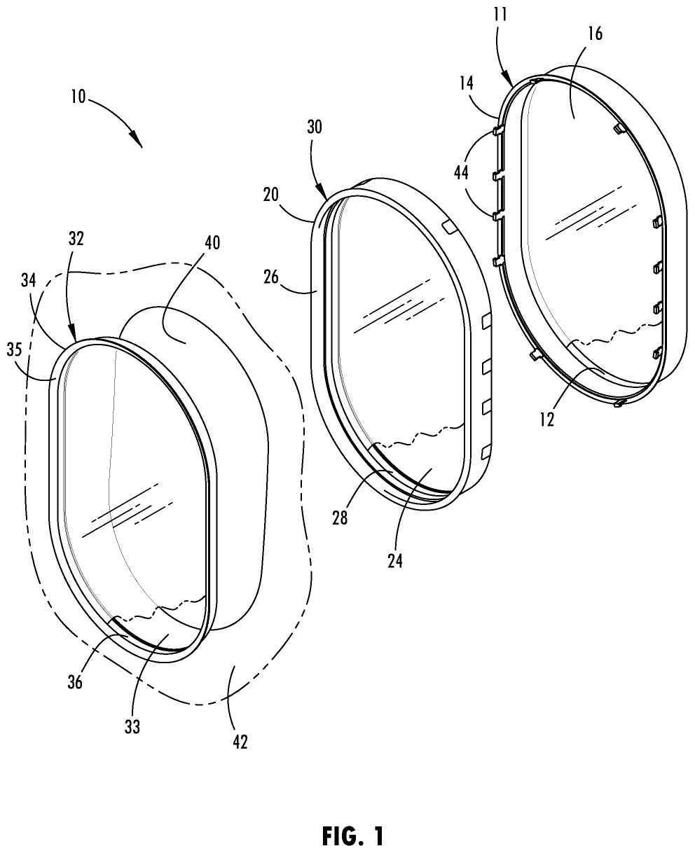

FIG. 1 illustrates an exploded view of an aerospace window assembly 10. Aerospace window assembly 10 may comprise a pressure pane 11, an electro-optic (“EO”) element 30, and a dust cover 32. Optionally, the aerospace window assembly is fit into an open aperture 40, of an aircraft fuselage 42.

Pressure pane 11 comprises a primary substrate 16 and a frame 14. Primary substrate 16 is substantially transparent and comprises a periphery. Frame 14 comprises an inner surface 12 and is disposed about the periphery of primary substrate 16, such that primary substrate 16 is in abutting contact with inner surface 12.

Electro-optic element 30 comprises a viewing region. The viewing region is variable between states of different light transmissivity and comprises an exterior EO substrate, a first electrode, a second electrode, an interior EO substrate, a sealing member, and an electro-optic medium. The exterior and interior EO substrates being substantially transparent. Further, the electro-optic element 30 may comprise an EO bezel 20. EO bezel 20 defines an inner opening 24, the inner opening 24 further defining an inner wall 26 of the EO bezel 20. Inner wall 26 comprising a EO channel 28. EO bezel 20 is disposed about a periphery of the viewing region, such that the viewing region is received into EO channel 28 of inner wall 26. EO bezel 20 may be of a foam construction with a high flexibility and resiliency, but also may include a rigid construction. Further, Electro-optic 30 is disposed such that it is inward from, proximate to, and substantially parallel to pressure pane 11.

Dust cover (“DC”) 32 comprises a viewing region. The viewing region comprising an exterior DC substrate, an interior DC substrate substantially parallel to the exterior DC substrate, and a coupling agent disposed therebetween. Further, the exterior DC and interior DC substrates are substantially transparent. Additionally, dust cover 32 may comprise a DC bezel 34. DC bezel 34 defines an inner opening 33, the inner opening 33 further defining an inner wall 35 of the DC bezel 34. Inner wall 35 comprising a DC channel 36. DC bezel 34 is disposed about a periphery of the dust cover viewing region, such that the viewing region is received into channel 36 of inner wall 35. DC bezel 34 may be of a foam construction with a high flexibility and resiliency, but also may include a rigid construction. Further, the dust cover 32 is disposed inward from and in a spaced apart relationship from the electro-optic element 30, defining a gap therebetween. The gap may be 30 mm or less, for example, the gap may be at, about, or less than 25 mm, 20 mm, 15 mm, 10 mm, 8 mm, 7 mm, 6 mm, 5 mm, 4 mm, 3.5 mm, and/or 3 mm.

In some embodiments, aerospace window assembly 10 may be disposed within an open aperture 40 of an aircraft fuselage 42, such that dust cover 32 is disposed interior the aircraft. Further, pressure pane 11 may also comprise a multitude of connectors 44 to secure pressure pane 11 to aircraft fuselage 42.

In operation, aerospace window assembly 10 is operable to provide a passenger positioned in the interior of the aircraft with a view of the exterior that is variably transmissive between a substantially transparent state and a dimmed state, while providing a protective barrier between electro-optic element 30 and the interior of the aircraft. Dust cover 32 is operable to resist breaking and maintain sufficient rigidity to prevent the electro-optic element 30 from breaking when a force of 680 N is applied to dust cover 32 in a direction of electro-optic element 30. Further, the present disclosure has the technical advantage of providing a stronger protective barrier, than prior solutions, between electro-optic element 30 and dust cover 32, with a reduced gap therebetween.

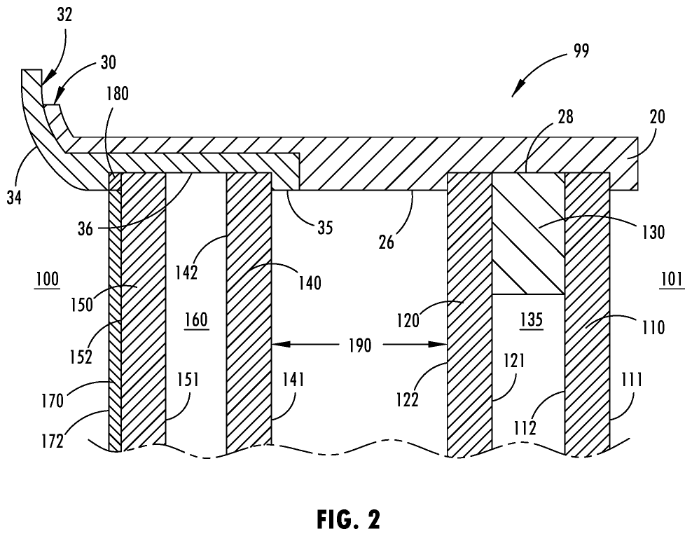

FIG. 2 illustrates a cross sectional schematic of a window 99 between an interior 100 and an exterior 101 of an aircraft. FIG. 2 is merely a schematic representation of window 99, and as such, some of the components have been distorted from their actual scale for pictorial clarity. Window 99 comprises an electro-optic element 30 and a dust cover 32, in a spaced apart relationship.

Electro-optic element 30 comprises a viewing region. The electro-optic element 30 viewing region comprising an exterior EO substrate 110, an interior EO substrate 120, a first electrode, a second electrode, a sealing member 130, and an electro-optic medium. Optionally, electro-optic element 30 may further comprise an EO bezel 20 and/or an interior guard 170.

Exterior EO substrate 110 comprises an exterior surface 111 and an interior surface 112. Exterior EO substrate 110 may be fabricated from any one of a number of materials that are transparent or substantially transparent in the visible region of the electromagnetic spectrum. For example, exterior EO substrate 110 may be constructed of alumino-silicate glass, such as Falcon commercially available from AGC; boroaluminosilicate (“BAS”) glass; polycarbonate, such as ProLens® polycarbonate, commercially available from Professional Plastics, which may be hard coated; polyethylene terephthalate, such as but not limited to Spallshield® CPET available from Kuraray®; soda lime glass, such as ultra-clear soda lime glass; float glass; natural and synthetic polymeric resins; plastics; and/or composites. Additionally, in some embodiments where EO substrate 110 is fabricated from glass, the glass may be chemically strengthened by a high temperature salt bath. While particular substrate materials are disclosed, for illustrative purposes only, numerous other substrate materials are likewise suitable—so long as the materials are at least substantially transparent and exhibit appropriate physical properties such as strength and tolerance to conditions of the device's environment, such as ultra-violet light exposure from the sun, humidity, and temperature extremes.

Interior EO substrate 120 comprises an exterior surface 121 and an interior surface 122. Interior EO substrate 120 may be fabricated from similar materials as exterior EO substrate 110. Further, interior EO substrate 120 is disposed in a spaced apart relationship with exterior EO substrate 110.

Interior surface 112 of exterior EO substrate 110 and exterior surface 121 of interior EO substrate 120 are associated with electrically conductive materials to serve as first and second electrodes, respectively. It is desirable that the electrically conductive materials of the electrodes: be substantially transparent in the visible region; bond reasonably well to the interior 110 and exterior 120 EO substrates; and be generally resistant to corrosion from materials contained within electro-optic element 30. Additionally, the electrically conductive materials may be further resistant to corrosion from materials in the aircraft exterior 101 atmosphere and any materials contained within a gap 190 between the electro-optic element 30 and dust cover 32; and exhibit minimal diffusion or specular reflectance. It is contemplated that the electrically conductive material may be fabricated from fluorine doped tin oxide, indium tin oxide, doped zinc oxide, or other materials known in the art.

Sealing member 130 is positioned between the first and second electrodes in a peripheral manner to define a chamber 135 in combination with the first and second electrodes. The sealing member may comprise any material that is capable of being adhesively bonded to the electrodes, to in turn seal chamber 135, such that the electro-optic medium does not inadvertently leak out. Additionally, it is further contemplated that the sealing member may alternatively extend all the way around the perimeter on interior surface 112 of exterior EO substrate 110 and exterior surface 121 of interior EO substrate 120. In such an embodiment, the electrode materials may be partially removed where the sealing member is positioned.

The electro-optic medium is disposed in chamber 135. Further, the electro-optic medium may comprise electroactive anodic and cathodic materials that upon activation, due to the application of an electronic voltage or potential, exhibit a change in absorbance at one or more wavelengths of the electromagnetic spectrum. In some embodiments, the change may be in the visible range of the electromagnetic spectrum. The electrochromic medium may be fabricated from any one of a number of materials, including, for example, those disclosed in U.S. Pat. No. 6,433,914, entitled “Color-Stabilized Electrochromic Devices,” which is herein incorporated by reference, in its entirety.

EO bezel 20 comprises an inner wall 26 having an EO channel 28. Further, EO bezel 20 is disposed about a periphery of the viewing window of the electro-optic element 30, such that the viewing window is received in EO channel 28. EO bezel 20 may be of a foam construction with a high flexibility and resiliency, but also may include a rigid construction.

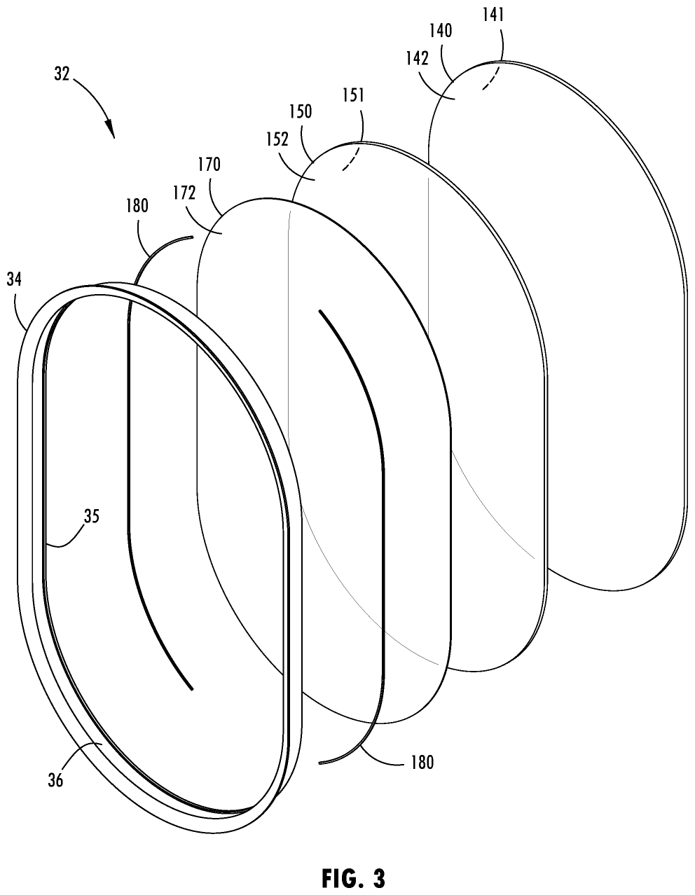

Dust cover 32, as additionally shown in the exploded perspective view of FIG. 3, comprises a viewing region. The dust cover 32 viewing region comprises an exterior DC substrate 140, an interior DC substrate 150, and a coupling agent. Further, dust cover 32 is disposed in a spaced apart relationship from the electro-optic element 30, defining a gap 190 therebetween. In some embodiments, dust cover 32 may further comprise a DC bezel 34.

Exterior DC substrate 140 comprises an exterior surface 141 and an interior surface 142. Exterior surface 141 of exterior DC substrate 140 defines gap 190 with the interior surface 122 of interior EO substrate 120. Gap 190 may be 30 mm or less, 25 mm or less, 20 mm or less, 15 mm or less, 10 mm or less, 8 mm or less, 7 mm or less, 6 mm or less, 5 mm or less, 4 mm or less, 3.5 mm or less, and/or 3 mm or less. Additionally, Exterior DC substrate 140 may be fabricated from the same or similar materials as Exterior EO substrate 110.

Interior DC substrate 150 comprises an exterior surface 151 and an interior surface 152. Additionally, Interior DC substrate 150 may be fabricated from the same or similar materials as Exterior EO substrate 110. Further, interior DC substrate 150 is disposed in a spaced apart relationship with exterior DC substrate 140, defining a space 160 therebetween. The coupling agent is disposed in space 160, thereby coupling exterior DC substrate 140 with interior DC substrate 150. Further, the coupling agent, for example, may comprise ethylene vinyl acetate (“EVA”); polyvinyl butyral (“PVB”); thermoplastic urethane (“TPU”); substantially transparent epoxy, such as OE1582 commercially available from United Adhesives, Inc.; acrylic; or silicone, such as but not limited to Acrylic 8146-2 Optically Clear Adhesive from 3M®, which may be a film, adhesive.

Exterior DC substrate 140, the coupling agent, and interior DC substrate 150, may be comprised of a combination of materials, such that the combination is substantially transparent and operable to resist breaking and maintain sufficient rigidity to prevent the electro-optic from breaking, when a force of 680 N, 900 N, 1200 N, 1500 N, 1800 N, 2000 N, and/or 2200 N is applied to the interior surface 152 of interior DC substrate 150 in the direction of the electro-optic element 30.

In some embodiments, exterior 140 and interior 150 DC substrates are comprised of BAS and the coupling agent is EVA or PVB. Further, the exterior 140 and interior 150 DC substrates are less than or equal to 1.0 mm, 0.7 mm, and/or 0.5 mm in thickness.

In an alternative embodiment, exterior 140 and interior 150 DC substrates are comprised of BAS with thicknesses less than or equal to 1.0 mm, 0.7 mm, and/or 0.5 mm. Further, the coupling agent may comprise a substantially transparent epoxy.

In another alternative embodiment, one of interior 140 and interior 150 DC substrates is comprised of polycarbonate. The other DC substrate is comprised of polyethylene terephthalate. The substrates may be less than 3 mm, 2 mm or less, or 1.5 mm or less in thickness. Further, the coupling agent may comprise an acrylic or silicone adhesive.

In another alternative embodiment, one of the interior 140 and interior 150 DC substrates is comprised of BAS, with thicknesses less than or equal to 1.0 mm, 0.7 mm, and/or 0.5 mm. The other DC substrate is comprised of polycarbonate, which may be less than or equal to 2 mm and/or 1.0 mm, in thickness. The coupling agent comprising a substantially transparent epoxy.

Additionally, it is contemplated that dust cover 32 may also comprise a DC bezel 34. DC bezel 34 comprises an inner wall 35 having a DC channel 36. Further, DC bezel 34 is disposed about a periphery of the viewing window of dust cover 32, such that the viewing window is received in DC channel 36. DC bezel 32 may be of a foam construction with a high flexibility and resiliency, but also may include a rigid construction.

In some embodiments, dust cover 32 may also comprise a substantially transparent interior guard 170. Interior guard 170 may comprise an anti-smudge, anti-fingerprint, scratch resistant, anti-reflective, and/or anti-bacterial coating or film. Further, interior guard 170 may be associated with interior surface 152 of interior DC substrate 150 and comprise an interior surface 172.

In some embodiments, dust cover 32 may also comprise a substrate stiffener 180. Substrate stiffener 180 is a substantially rigid member disposed on or about a perimeter of exterior DC substrate 140 and/or interior DC substrate 150 on one or more side thereof. Accordingly, substrate stiffener 180 may be associated with the exterior and/or interior surfaces 141, 142 of exterior DC substrate 140; the exterior and/or interior surfaces 152, 151 of interior DC substrate 150; and/or interior surface 172 of interior guard 170. Additionally, in some of these embodiments, substrate stiffener 180 may be at or about 1.5 mm thick and/or made of metal, plastic, and or glass. Further, substrate stiffener 180 may be disposed on or about the entirety or a portion of the perimeter.

In some embodiments, gap 190 may be enhanced to improve the insulating properties of window 99. For example, gap 190 may comprise an insulating gas or vacuum. Further, in such an embodiment, gap 190 may have a seal to render all or a portion of gap 190 airtight.

In operation, the electro-optic element 30 applies an electrical potential to the electro-optic medium via the first and second electrodes. Accordingly, the electro-optic medium may change from a light transmissive state to a darkened state, in effect, darkening the aerospace window 99.

Additionally, in operation, the dust cover 32 of the window 99 protects the electro-optic element 30 from impacts. The dust cover 32 possesses sufficient rigidity to prevent the exterior DC substrate 140 from coming into contact with the interior EO substrate 120 with sufficient force to break electro-optic element 30. Further, dust cover 32 may be such that its weight is kept low, it prevents spalling when impacted, and/or it reduces smudging and scratching. Accordingly, in some embodiments, upon breakage of dust cover 32, substrate shards and fragments may be minimized or eliminated. Specifically, the fragments and shards may be minimized or eliminated when the force is applied to dust cover 32 in the direction of the electro-optic element 30.

The present disclosure has the technical advantage of enabling the window 99 to sustain impacts without breaking the expensive electro-optic element 30 and having the dust cover 32 disposed with a smaller gap 190 between the electro-optic element 30 and the dust cover 32. Additionally, the present disclosure has the advantage of achieving this outcome while keeping weight low, minimizing spalling, and remaining transparent. In some embodiments, window 99 may further have the advantage of being fire resistant. Accordingly, embodiments of window 99 may pass United States regulatory flammability testing.

As used herein, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The terms “including,” “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element preceded by “comprises a . . . ” does not, without more constraints, preclude the existence of additional identical elements in the process, method, article, or apparatus that comprises the elements.

The term “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; A and C in combination; B and C in combination; or A, B, and C in combination.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

1. A window assembly comprising:
a dust cover, the dust cover comprising a first substrate and a second substrate in a spaced apart relationship, coupled together by a substantially transparent coupling agent therebetween,
wherein the dust cover is operable, when a force of 680 N is applied to the dust cover, to:
resist breaking, and
maintain sufficient rigidity to prevent the electro-optic from breaking; and
an electro-optic element, the electro-optic element comprising:
a third substrate,
a fourth substrate, wherein the fourth substrate is in a spaced apart relationship with the third substrate,
a primary seal, the primary seal defining a chamber with the third and fourth substrates, and
an electro-optic medium disposed in the chamber.

2. The window assembly of claim 1, wherein a gap between the second and third substrates are equal to or less than approximately 30 mm.

3. The window assembly of claim 1, wherein upon initially breaking, the dust cover does not spall.

4. The window assembly of claim 1, wherein the applied force is 900 N.

5. The window assembly of claim 1, wherein the first and second substrates are aluminosilicate glass.

6. The window assembly of claim 5, wherein the first and second substrates are each less than or equal to 1.0 mm in thickness.

7. The window assembly of claim 6, wherein the first and second substrates are each less or equal to 0.7 mm in thickness.

8. The window assembly of claim 7, wherein the first and second substrates are each less than or equal to 0.5 mm in thickness.

9. The window assembly of claim 5, wherein the coupling agent is ethylene vinyl acetate.

10. The window assembly of claim 9, wherein the first substrate is approximately 0.7 mm in thickness and the second substrate is approximately 1.0 mm in thickness.

11. The widow assembly of claim 1, wherein the applied force is 1,000 N.

12. The window assembly of claim 1, wherein the applied force is 1,200 N.

13. The window assembly of claim 1, further comprising a substrate stiffener disposed about at least part of a perimeter of at least one of the first and second substrates.

14. The window assembly of claim 1, wherein one of the first substrate and the second substrate comprise chemically strengthened glass.

15. A window assembly comprising:
a pressure pane;
a bezel proximate a periphery of the pressure pane and defining an inner opening, the bezel including an inner wall with a channel;
an electro-optic element disposed in the inner opening and configured for reception in the channel of the inner wall, the electro-optic element having a changeable degree of light transmission; and
a dust cover proximate the bezel, the dust cover comprising a first substrate and a second substrate in a spaced apart relationship, coupled together by a substantially transparent coupling agent therebetween.
wherein the dust cover is operable, when a force of 680 N is applied to the dust cover, to:
resist breaking, and
maintain sufficient rigidity to prevent the electro-optic from breaking.

16. The window assembly of claim 15, wherein the applied force is 900 N.

17. A window assembly comprising:
an electro-optic element configured for reception in a channel of an inner wall, the electro-optic element having a changeable degree of light transmission; and
a dust cover configured for reception proximate a bezel, the dust cover comprising a first substrate and a second substrate in a spaced apart relationship, coupled together by a substantially transparent coupling agent therebetween,
wherein the dust cover is operable, when a force of 680 N is applied to the dust cover to:
resist breaking, and
maintain sufficient rigidity to prevent the electro-optic from breaking.

18. The window assembly of claim 17, wherein a gap between the second substrate and the electro-optic element are equal to or less than 30 mm.

19. The window assembly of claim 17, wherein upon initially breaking, the dust cover does not spall.

20. The window assembly of claim 17, wherein the applied force is 900 N.
